(19) United States
(12) Patent Application Publication
(10) Pub. No.: US 2017/0308149 A1
(43) Pub. Date: Oct. 26, 2017

(54) DATA RECORDING APPARATUS WITH POWER SAVING FUNCTION

(71) Applicant: Jogtek Corp., Taipei City (TW)

(72) Inventors: Wei-Chun HUANG, Taipei City (TW); Tsung-Hsing HSIEH, Taipei City (TW)

(21) Appl. No.: 15/133,869

(22) Filed: Apr. 20, 2016

(51) Int. Cl. G06F 1/32; G06F 13/42

(52) U.S. Cl. CPC G06F 1/3243; G06F 1/3287; G06F 13/4282

(57) ABSTRACT

A data recording apparatus with a power saving function includes a micro control unit, a switch unit, a timing unit, a battery, a boosting integrated circuit, a sensing unit and a dynamic tag. The switch unit is electrically connected to the micro control unit. The timing unit is electrically connected to the switch unit. The battery is electrically connected to the timing unit. The boosting integrated circuit is electrically connected to the micro control unit and the switch unit. The sensing unit is electrically connected to the boosting integrated circuit. The dynamic tag is electrically connected to the micro control unit. The timing unit turns on the switch unit once a predetermined time, so that the battery provides a battery power through the timing unit to drive the micro control unit and the boosting integrated circuit.

### BACKGROUND OF THE INVENTION

### Field of the Invention

The present invention relates to a data recording apparatus, and especially relates to a data recording apparatus with a power saving function.

### Description of the Related Art

The user uses the related art data recording apparatus to record the value sensed by the sensor. Therefore, the data recording apparatus is very important.

However, the disadvantage of the related art data recording apparatus is that the power consumption is too fast. The battery needs to be changed in a short time. It is very inconvenient.

### SUMMARY OF THE INVENTION

In order to solve the above-mentioned problems, an object of the present invention is to provide a data recording apparatus with a power saving function.

In order to achieve the object of the present invention mentioned above, the data recording apparatus comprises a micro control unit, a switch unit, a timing unit, a battery, a boosting integrated circuit, a sensing unit and a dynamic tag. The switch unit is electrically connected to the micro control unit. The timing unit is electrically connected to the switch unit. The battery is electrically connected to the timing unit. The boosting integrated circuit is electrically connected to the micro control unit and the switch unit. The sensing unit is electrically connected to the boosting integrated circuit. The dynamic tag is electrically connected to the micro control unit. The timing unit turns on the switch unit once a predetermined time (namely, every predetermined time), so that the battery provides a battery power through the timing unit to drive the micro control unit and the boosting integrated circuit.

Moreover, in an embodiment, the data recording apparatus mentioned above further comprises a digital resistor circuit electrically connected to the micro control unit and the timing unit. The digital resistor circuit comprises an inter-integrated circuit interface, a permanent register, a non-permanent register and a variable resistor. The permanent register is electrically connected to the inter-integrated circuit interface. The non-permanent register is electrically connected to the permanent register. The variable resistor is electrically connected to the non-permanent register and the timing unit.

Moreover, in an embodiment, the data recording apparatus mentioned above further comprises a fixed resistor electrically connected to the micro control unit and the timing unit.

Moreover, in an embodiment, the data recording apparatus mentioned above further comprises a first connection interface electrically connected to the micro control unit and the sensing unit.

Moreover, in an embodiment, the data recording apparatus mentioned above further comprises a second connection interface electrically connected to the micro control unit and the dynamic tag.

Moreover, in an embodiment, the data recording apparatus mentioned above further comprises a third connection interface electrically connected to the micro control unit and the digital resistor circuit.

Moreover, in an embodiment, the switch unit is, for example but not limited to, a super low leakage switch. The timing unit is, for example but not limited to, a nanometer energy system timer.

Moreover, in an embodiment, the battery is, for example but not limited to, a button battery. The sensing unit is, for example but not limited to, a temperature sensor or a humidity sensor.

Moreover, in an embodiment, the dynamic tag is, for example but not limited to, a dual-interface radio frequency identification tag.

Moreover, in an embodiment, the first connection interface is, for example but not limited to, a serial peripheral interface, an inter-integrated circuit or a general purpose input output. The second connection interface is, for example but not limited to, a serial peripheral interface, an inter-integrated circuit or a general purpose input output. The third connection interface is, for example but not limited to, a serial peripheral interface, an inter-integrated circuit or a general purpose input output.

The advantage of the present invention is to reduce the power consumption of the data recording apparatus.

### BRIEF DESCRIPTION OF DRAWING

FIG. 1 shows a block diagram of the first embodiment of the data recording apparatus of the present invention.

FIG. 2 shows a block diagram of the second embodiment of the data recording apparatus of the present invention.

### DETAILED DESCRIPTION OF THE INVENTION

Please refer to following detailed description and figures for the technical content of the present invention. The following detailed description and figures are referred for the present invention, but the present invention is not limited to it.

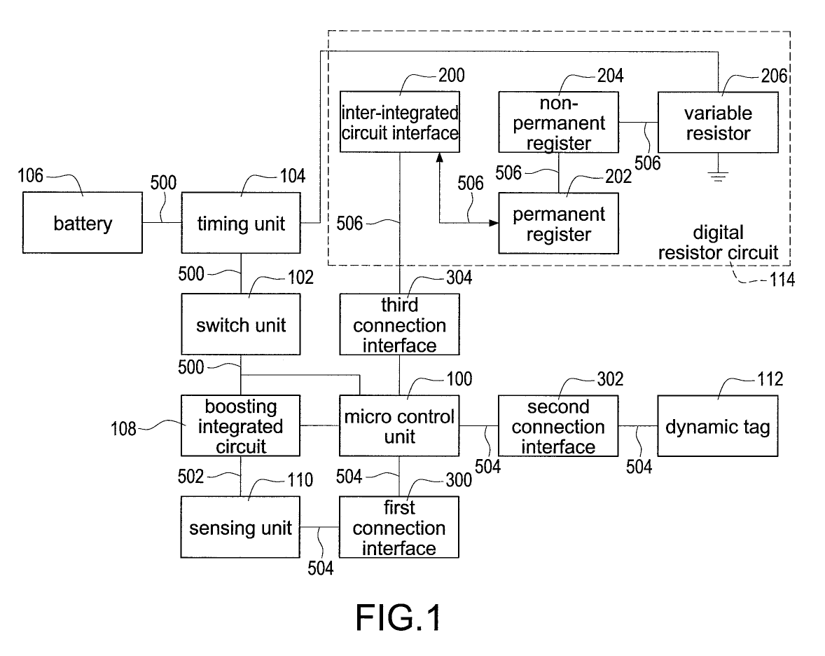

FIG. 1 shows a block diagram of the first embodiment of the data recording apparatus of the present invention. A data recording apparatus 10 with a power saving function is used to sense, for examples the temperature or the humidity, to record data. The data recording apparatus 10 includes a micro control unit 100, a switch unit 102, a timing unit 104, a battery 106, a boosting integrated circuit 108, a sensing unit 110, a dynamic tag 112, a digital resistor circuit 114, a first connection interface 300, a second connection interface 302 and a third connection interface 304. The digital resistor circuit 114 comprises an inter-integrated circuit interface 200, a permanent register 202, a non-permanent register 204 and a variable resistor 206.

The switch unit 102 is electrically connected to the micro control unit 100. The timing unit 104 is electrically connected to the switch unit 102. The battery 106 is electrically connected to the timing unit 104. The boosting integrated circuit 108 is electrically connected to the micro control unit 100 and the switch unit 102. The sensing unit 110 is electrically connected to the boosting integrated circuit 108. The dynamic tag 112 is electrically connected to the micro control unit 100. The digital resistor circuit 114 is electrically connected to the micro control unit 100 and the timing unit 104. The inter-integrated circuit interface 200 is electrically connected to the micro control unit 100 and the timing unit 104. The permanent register 202 is electrically connected to the inter-integrated circuit interface 200. The non-permanent register 204 is electrically connected to the permanent register 202. The variable resistor 206 is electrically connected to the non-permanent register 204 and the timing unit 104. The first connection interface 300 is electrically connected to the micro control unit 100 and the sensing unit 110. The second connection interface 302 is electrically connected to the micro control unit 100 and the dynamic tag 112. The third connection interface 304 is electrically connected to the micro control unit 100 and the digital resistor circuit 114.

The battery 106 provides a battery power 500 to the timing unit 104. After the timing unit 104 receives the battery power 500, the timing unit 104 times a predetermined time. After the timing unit 104 finishes timing the predetermined time, the timing unit 104 turns on the switch unit 102. At this time, the timing unit 104 sends the battery power 500 through the switch unit 102 to the micro control unit 100 and the boosting integrated circuit 108. The micro control unit 100 receives the battery power 500. The battery power 500 is used to drive the micro control unit 100. The timing unit 104 turns on the switch unit 102 once (namely, every) the predetermined time (for example, five minutes), so that the battery 106 provides the battery power 500 through the timing unit 104 to drive the micro control unit 100 and the boosting integrated circuit 108.

After the boosting integrated circuit 108 receives the battery power 500, the boosting integrated circuit 108 boosts the battery power 500 to obtain a boosted power 502. The boosting integrated circuit 108 sends the boosted power 502 to the sensing unit 110 to drive the sensing unit 110. After the sensing unit 110 receives the boosted power 502, the sensing unit 110 senses, for examples the temperature or the humidity, to obtain a sensing data 504.

In this embodiment, the sensing unit 110 is a temperature sensor or a humidity sensor, but the present invention is not limited to them. The micro control unit 100 receives the sensing data 504 sensed by the sensing unit 110 through the first connection interface 300. The first connection interface 300 is a serial peripheral interface, an inter-integrated circuit or a general purpose input output, but the present invention is not limited to them. At this time, the micro control unit 100 sends the sensing data 504 to the dynamic tag 112 through the second connection interface 302. After the dynamic tag 112 receives the sensing data 504, the dynamic tag 112 displays the sensing data 504 or stores the sensing data 504 in the dynamic tag 112.

Moreover, the micro control unit 100 adjusts the digital resistor circuit 114 through the third connection interface 304. The predetermined time is determined by the variable resistor 206 of the digital resistor circuit 114, so that the micro control unit 100 can determine the predetermined time by adjusting the digital resistor circuit 114. Moreover, the micro control unit 100 sends a resistor signal 506 through the third connection interface 304. After the inter-integrated circuit interface 200 receives the resistor signal 506, the inter-integrated circuit interface 200 sends the resistor signal 506 to the permanent register 202. After the permanent register 202 receives the resistor signal 506, the permanent register 202 adjusts the variable resistor 206 through the non-permanent register 204 to control the predetermined time.

The switch unit 102 is, for example but not limited to, a super low leakage switch. The timing unit 104 is, for example but not limited to, a nanometer energy system timer. The battery 106 is, for example but not limited to, a button battery. The sensing unit 110 is, for example but not limited to, a temperature sensor or a humidity sensor. The first connection interface 300 is, for example but not limited to, a serial peripheral interface, an inter-integrated circuit or a general purpose input output. The second connection interface 302 is, for example but not limited to, a serial peripheral interface, an inter-integrated circuit or a general purpose input output. The third connection interface 304 is, for example but not limited to, a serial peripheral interface, an inter-integrated circuit or a general purpose input output. The dynamic tag 112 is a dual-interface radio frequency identification tag.

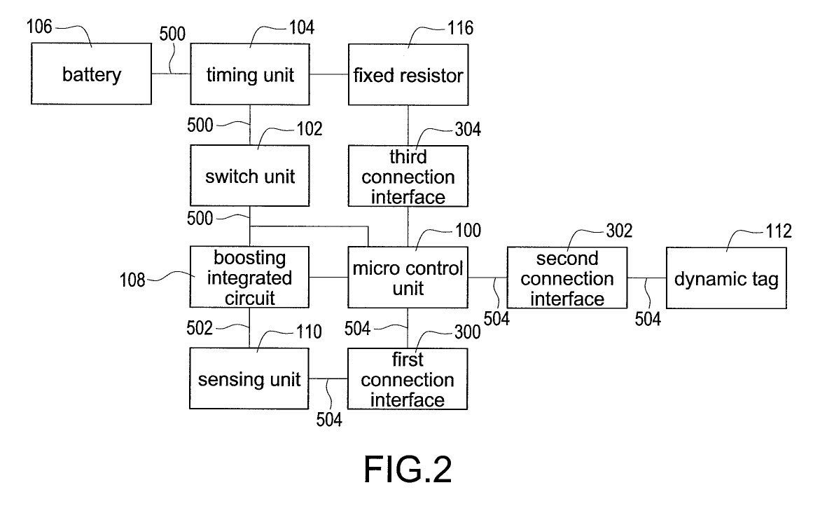

FIG. 2 shows a block diagram of the second embodiment of the data recording apparatus of the present invention. A data recording apparatus 10 with a power saving function is used to sense, for examples the temperature or the humidity, to record data. The data recording apparatus 10 includes a micro control unit 100, a switch unit 102, a timing unit 104, a battery 106, a boosting integrated circuit 108, a sensing unit 110, a dynamic tag 112, a fixed resistor 116, a first connection interface 300, a second connection interface 302 and a third connection interface 304.

The switch unit 102 is electrically connected to the micro control unit 100. The timing unit 104 is electrically connected to the switch unit 102. The battery 106 is electrically connected to the timing unit 104. The boosting integrated circuit 108 is electrically connected to the micro control unit 100 and the switch unit 102. The sensing unit 110 is electrically connected to the boosting integrated circuit 108. The dynamic tag 112 is electrically connected to the micro control unit 100. The fixed resistor 116 is electrically connected to the micro control unit 100 and the timing unit 104. The first connection interface 300 is electrically connected to the micro control unit 100 and the sensing unit 110. The second connection interface 302 is electrically connected to the micro control unit 100 and the dynamic tag 112. The third connection interface 304 is electrically connected to the micro control unit 100 and the fixed resistor 116.

The battery 106 provides a battery power 500 to the timing unit 104. After the timing unit 104 receives the battery power 500, the timing unit 104 times a predetermined time. After the timing unit 104 finishes timing the predetermined time, the timing unit 104 turns on the switch unit 102. At this time, the timing unit 104 sends the battery power 500 through the switch unit 102 to the micro control unit 100 and the boosting integrated circuit 108. The micro control unit 100 receives the battery power 500. The battery power 500 is used to drive the micro control unit 100. The timing unit 104 turns on the switch unit 102 once (namely, every) the predetermined time (for example, five minutes), so that the battery 106 provides the battery power 500 through the timing unit 104 to drive the micro control unit 100 and the boosting integrated circuit 108. The predetermined time is determined by the fixed resistor 116.

After the boosting integrated circuit 108 receives the battery power 500, the boosting integrated circuit 108 boosts the battery power 500 to obtain a boosted power 502. The boosting integrated circuit 108 sends the boosted power 502 to the sensing unit 110 to drive the sensing unit 110. After the sensing unit 110 receives the boosted power 502, the sensing unit 110 senses, for examples the temperature or the humidity, to obtain a sensing data 504.

In this embodiment, the sensing unit 110 is a temperature sensor or a humidity sensor, but the present invention is not limited to them. The micro control unit 100 receives the sensing data 504 sensed by the sensing unit 110 through the first connection interface 300. The first connection interface 300 is a serial peripheral interface, an inter-integrated circuit or a general purpose input output, but the present invention is not limited to them. At this time, the micro control unit 100 sends the sensing data 504 to the dynamic tag 112 through the second connection interface 302. After the dynamic tag 112 receives the sensing data 504, the dynamic tag 112 displays the sensing data 504 or stores the sensing data 504 in the dynamic tag 112.

The switch unit 102 is, for example but not limited to, a super low leakage switch. The timing unit 104 is, for example but not limited to, a nanometer energy system timer. The battery 106 is, for example but not limited to, a button battery. The sensing unit 110 is, for example but not limited to, a temperature sensor or a humidity sensor. The first connection interface 300 is, for example but not limited to, a serial peripheral interface, an inter-integrated circuit or a general purpose input output. The second connection interface 302 is, for example but not limited to, a serial peripheral interface, an inter-integrated circuit or a general purpose input output. The third connection interface 304 is, for example but not limited to, a serial peripheral interface, an inter-integrated circuit or a general purpose input output. The dynamic tag 112 is, for example but not limited to, a dual-interface radio frequency identification tag.

The advantage of the present invention is to reduce the power consumption of the data recording apparatus.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A data recording apparatus with a power saving function, the data recording apparatus comprising:
a micro control unit;
a switch unit electrically connected to the micro control unit;
a timing unit electrically connected to the switch unit;
a battery electrically connected to the timing unit;
a boosting integrated circuit electrically connected to the micro control unit and the switch unit;
a sensing unit electrically connected to the boosting integrated circuit; and
a dynamic tag electrically connected to the micro control unit,
wherein the timing unit turns on the switch unit once a predetermined time, so that the battery provides a battery power through the timing unit to drive the micro control unit and the boosting integrated circuit.

2. The data recording apparatus in claim 1 further comprising:
a digital resistor circuit electrically connected to the micro control unit and the timing unit,
wherein the digital resistor circuit comprises:
an inter-integrated circuit interface;
a permanent register electrically connected to the inter-integrated circuit interface;
a non-permanent register electrically connected to the permanent register; and
a variable resistor electrically connected to the non-permanent register and the timing unit.

3. The data recording apparatus in claim 1 further comprising:
a fixed resistor electrically connected to the micro control unit and the timing unit.

4. The data recording apparatus in claim 2 further comprising:
a first connection interface electrically connected to the micro control unit and the sensing unit.

5. The data recording apparatus in claim 4 further comprising:
a second connection interface electrically connected to the micro control unit and the dynamic tag.

6. The data recording apparatus in claim 5 further comprising:
a third connection interface electrically connected to the micro control unit and the digital resistor circuit.

7. The data recording apparatus in claim 6, wherein the switch unit is a super low leakage switch; the timing unit is a nanometer energy system timer.

8. The data recording apparatus in claim 7, wherein the battery is a button battery; the sensing unit is a temperature sensor or a humidity sensor.

9. The data recording apparatus in claim 8, wherein the dynamic tag is a dual-interface radio frequency identification tag.

10. The data recording apparatus in claim 9, wherein the first connection interface is a serial peripheral interface, an inter-integrated circuit or a general purpose input output; the second connection interface is a serial peripheral interface, an inter-integrated circuit or a general purpose input output; the third connection interface is a serial peripheral interface, an inter-integrated circuit or a general purpose input output.
